(19) United States
(12) Patent Application Publication
(10) Pub. No.: US 2003/0175010 A1
(43) Pub. Date: Sep. 18, 2003

(54) Image recording and replaying apparatus

(75) Inventors: Kenji Nomura, Tokyo (JP); Daisuke Soma, Tokyo (JP); Muneki Ishida, Tokyo (JP); Hiroyuki Tamakoshi, Kanagawa-ken (JP); Takashi Kondo, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/384,885

(22) Filed: Mar. 10, 2003

(30) Foreign Application Priority Data
Mar. 12, 2002 (JP) 2002-067085

(51) Int. Cl. H04N 5/76; H04N 5/225

(52) U.S. Cl. 386/46; 386/117

(57) ABSTRACT

An image recording and replaying apparatus has a main unit. A collapsible liquid crystal display monitor is provided on a side of the main unit and is detachable from the main unit. An operating unit is provided on an upper side of the main unit and is also detachable from the main unit. The main unit includes a control signal receiving unit that receives control signals from the operating unit and an image signal transmission unit that transmits image signals to the monitoring unit for displaying images.

### BACKGROUND OF THE INVENTION

1. Field of the Invention

The present invention relates to apparatuses for recording and replaying image signals, such as videotape recorders (VTRS) and digital cameras.

2. Description of the Related Art

In general, conventional image recording and replaying apparatuses are provided with user-friendly remote control units. An example of such image recording and replaying apparatuses is shown in FIGS. 3 and 4. Referring to FIG. 3, a camcorder main unit 10 (hereinafter, referred to as main unit) is provided with a detachable liquid crystal display monitor 11. The main unit 10, on one face, has an AV signal transmission unit 12 that transmits image signals during recording or replaying to the liquid crystal display monitor 11 and a control signal-receiving unit 13 that receives control signals for remote control.

At the lower portion of the liquid crystal display monitor 11, an operation unit 14 is provided for operation of the camera angle and zooming. The operation unit 14 controls the movement of a camera unit 15. At the top, the liquid crystal display monitor 11 is provided with a control signal transmission unit 16 that transmits control signals for remote control, and an AV signal-receiving unit 17 that receives image signals from the main unit 10, when the liquid crystal display monitor 11 is detached from the main unit 10.

FIG. 4 is a schematic view showing remote control of the camera unit 15 by a remote control unit 18 with a liquid crystal display monitor that is detached from the main unit 10. Upon the operation of the operation unit 14, the remote control unit 18 with liquid crystal display monitor transmits control signals through the control signal transmission unit 16, while the main unit 10 receives the control signals through the control signal-receiving unit 13 to control the operations of the camera angle and zooming of the camera unit 15. On the other hand, the main unit 10 transmits image signals from the camera unit 15 via the AV signal transmission unit 12 to the remote control unit 18, while the remote control unit 18 receives the image signals from the AV signal-receiving unit 17 to display images on the liquid crystal display monitor 11.

In such an image recording and replaying apparatus, the operation unit of the remote control unit and the liquid crystal display monitor are integrated. Thus, arrangement of the attachment of the remote control unit to the main unit is limited. As a result, the operating unit is difficult to operate, and design versatility of the remote control unit is limited.

### SUMMARY OF THE INVENTION

An object of the present invention is to provide an image recording and replaying apparatus that is easy to operate when a display monitor is attached to a main unit and that has superior design versatility.

An image recording and replaying apparatus according to the present invention includes a main unit having means for recording and replaying image signals; an operating unit that operates the main unit; and a monitoring unit that displays images, wherein the operating unit and the monitoring unit are attachable to and detachable from the main unit, and the main unit includes control signal receiving means that receives control signals from the operating unit and image signal transmission means that transmits image signals to the monitoring unit for displaying the images.

In a preferred embodiment of the image recording and replaying apparatus, the operating unit and the monitoring unit that have been detached from the main unit are attached to each other, and the monitoring unit with the operating unit includes control signal transmission means that transmits the control signals to the main unit and image signal receiving means that receives the image signals from the main unit.

In another preferred embodiment of the image recording and replaying apparatus, the main unit, the operating unit, and the monitoring unit each have a dedicated driving power supply.

Since the monitoring unit and the operating unit are detachable from the main unit, the main body has high design versatility with respect to the positions of attachment of these units without restriction of operationality.

Since the monitoring unit and the operating unit that have been detached from the main unit are integrated, a user can remotely controls the main unit while viewing images on the monitoring unit.

Since the monitoring unit and the operating unit each have a dedicated driving power supply, these units can be independently used as a remote control unit or a monitoring unit.

### BRIEF DESCRIPTION OF THE DRAWINGS

FIG. 1 is a schematic view of an image recording and replaying apparatus according to the present invention;

FIG. 2 is a schematic view of the image recording and replaying apparatus in use;

FIG. 3 is a schematic view of a conventional image recording and replaying apparatus; and

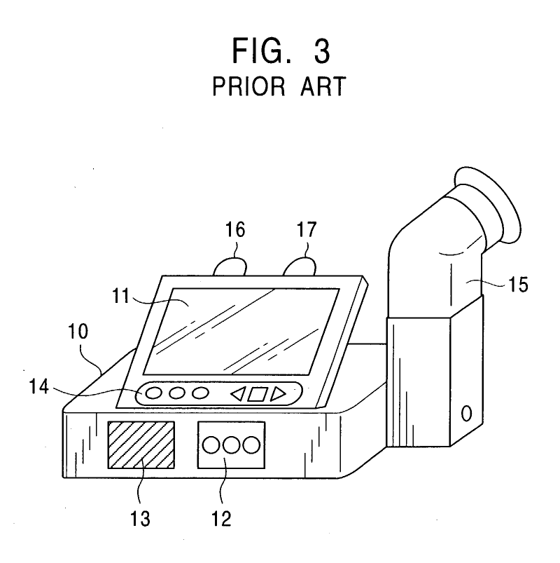

FIG. 4 is a schematic view of an operation of the conventional image recording and replaying apparatus.

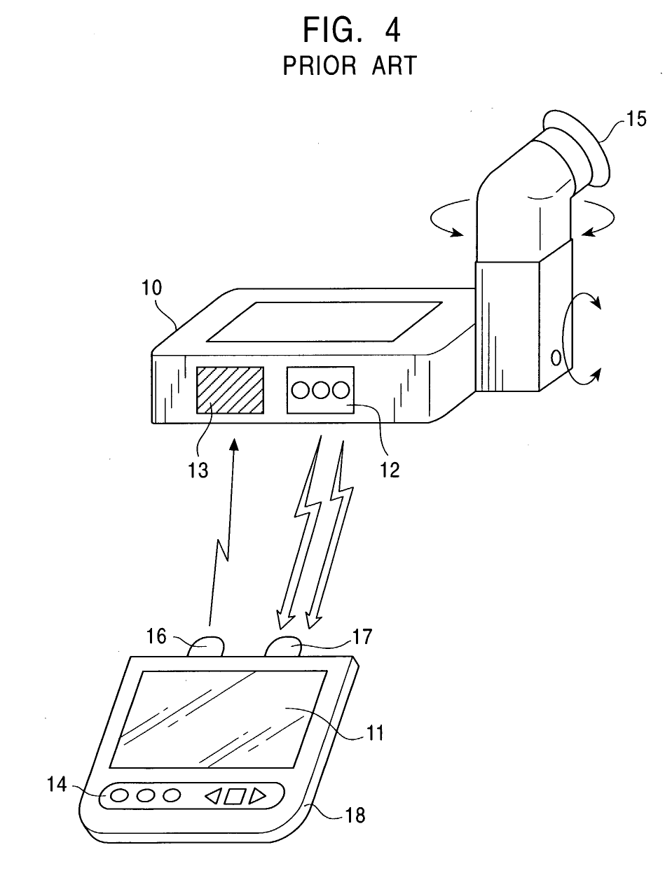

### DESCRIPTION OF THE PREFERRED EMBODIMENTS

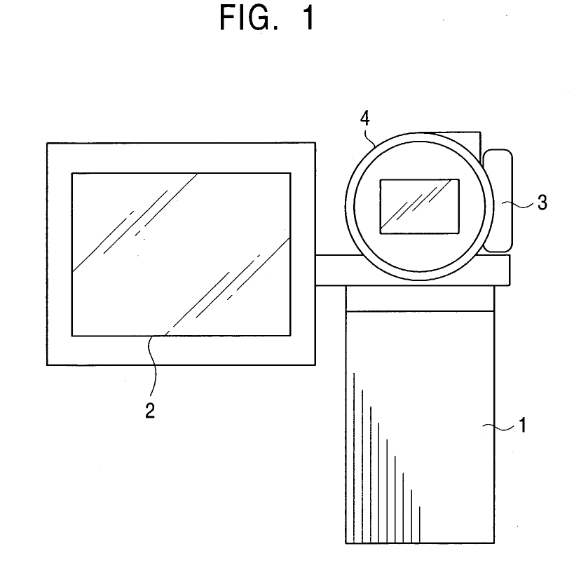

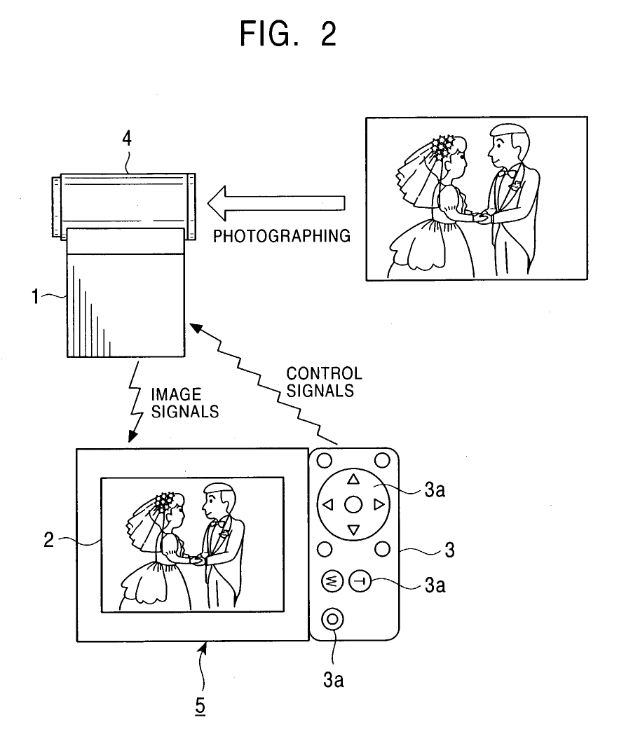

FIG. 1 is a schematic view of an image recording and replaying apparatus according to the present invention, and FIG. 2 is a schematic view of the image recording and replaying apparatus in use.

A collapsible liquid crystal display monitor 2 is provided on a side face of a main unit 1 of the image recording and replaying apparatus. The liquid crystal display monitor 2 is detachable from the main unit 1. An operating unit 3 is provided on an upper side face of the main unit 1. The operating unit 3 is also detachable from the main unit 1. A camera unit 4 is provided on the top of the main unit 1.

Referring to FIG. 2, the liquid crystal display monitor 2 and the operating unit 3 detached from the main unit 1 can be integrated, and such a combination functions as a liquid crystal display monitor with operating unit 5.

The main unit 1 has an image recording and replaying means (not shown) that records image signals from the camera unit 4 on to a medium (not shown), i.e., a videotape or a disk, and replays image signals recorded on the medium.

Furthermore, the main unit 1 has an image signal transmission means (not shown) that transmits image signals by air to the liquid crystal display monitor with operating unit 5 (liquid crystal display monitor 2) to display images based on the image signals on the liquid crystal display monitor 2.

The liquid crystal display monitor with operating unit 5 has a control signal transmission means (not shown) having an infrared light-emitting diode (not shown) to emit infrared control signals upon the operation. The main unit 1 has a control signal receiving means (not shown) having a photo detector (not shown) for receiving the control signals from the control signal transmission means. Upon receiving the control signals, the main unit 1 controls the operations such as photographing and zooming of the camera unit 4.

Referring to FIG. 2, the remote control operation of the main unit 1 will now be described. A user (not shown) positions the main unit 1 at a desired place with a tripod mount for photographing. The image signals of images taken by the camera unit 4 are transmitted from the image signal transmission means by air to the liquid crystal display monitor with operating unit 5 and the same images are displayed on the liquid crystal display monitor 2. The user views the liquid crystal display monitor 2 and operates operation keys 3a of the operating unit 3 for zoom-in, zoom-out, and start/end of recording.

The control signal receiving means of the main unit 1 receives the control signals from the control signal transmission means of the liquid crystal display monitor with operating unit 5 (operating unit 3), and the main unit 1 operates according to the received control signals.

Since the operating unit 3 has a battery power supply (not shown), it can be independently used as a remote control unit when it is detached from the main unit 1. Since the liquid crystal display monitor 2 also has a battery power supply (not shown), it can be independently used. These power supplies may be secondary batteries that can be recharged when the operating unit 3 and the liquid crystal display monitor 2 are attached to the main unit 1 or that can be recharged using an AC adapter. The power source of the main unit 1 may be either a rechargeable secondary battery or an AC adapter (not shown) and thus has a battery charger (not shown) for recharging the secondary battery.

In the above embodiment, the image signals are transmitted from the main unit 1 to the liquid crystal display monitor with operating unit 5 (liquid crystal display monitor 2). In an image recording and replaying apparatus such as a camcorder that records and replays voice signals, AV signals including image signals and voice signals are transmitted.

In the above embodiment, the image signals are transmitted by radio waves, while the control signals are transmitted by infrared light. However, both signals may be transmitted by radio waves, any light, or any other transmission means.

In the above embodiment, the liquid crystal display monitor 2 has the image signal receiving means, whereas the operating unit 3 has the control signal transmission means. For the liquid crystal display monitor with operating unit 5, both the image signal receiving means and the control signal transmission means may be either one of the liquid crystal display monitor 2 and the operating unit 3 that can transmit and receive these signals.

What is claimed is:

1. An image recording and replaying apparatus comprising:
a main unit having means for recording and replaying image signals;
an operating unit that operates the main unit; and
a monitoring unit that displays images,
wherein the operating unit and the monitoring unit are attachable to and detachable from the main unit, and the main unit includes control signal receiving means that receives control signals from the operating unit and image signal transmission means that transmits image signals to the monitoring unit for displaying the images.

2. The image recording and replaying apparatus according to claim 1, wherein the operating unit and the monitoring unit that have been detached from the main unit are attached to each other, and the monitoring unit with the operating unit includes control signal transmission means that transmits the control signals to the main unit and image signal receiving means that receives the image signals from the main unit.

3. The image recording and replaying apparatus according to claim 1, wherein the main unit, the operating unit, and the monitoring unit each have a dedicated driving power supply.
